(19) United States
(12) Patent Application Publication
(10) Pub. No.: US 2009/0322460 A1
(43) Pub. Date: Dec. 31, 2009

(54) HIGH-FREQUENCY SWITCHING-TYPE DIRECT-CURRENT RECTIFIER

(76) Inventor: Hsun-I LIN, Yongkang City (TW)

Correspondence Address: LEONG C LEI, PMB # 1008, 1867 YGNACIO VALLEY ROAD, WALNUT CREEK, CA, 94598, US

(21) Appl. No.: 12/145,519

(22) Filed: Jun. 25, 2008

(51) Int. Cl. H01F 27/08

(52) U.S. Cl. 336/62

(57) ABSTRACT

The present invention relates to a novel structure of a transformer for a high-frequency switching-type direct-current (DC) rectifier, and particularly to an improved structure of a transformer applicable to a large-current low-voltage high-frequency switching-type rectifier, wherein the transformer is comprised of a ring-shaped iron core (made of materials such as dust core or nanometer crystalline silicon or amorphous silicone), which is provided with a primary side formed with winding(s) of copper wire(s), coupling with a secondary side that is formed with a newly-developed module or block, which replaces the secondary side that was constructed to provide output with copper wires or copper plate with wire wound thereon. A cooling water tube is arranged in the secondary-side module to remove heat with the water so as to maintain normal temperatures of the transformer in a pollution-free manner with reduced size and weight and easy assembling and reduced costs of the transformer.

### BACKGROUND OF THE INVENTION

(a) Technical Field of the Invention

The present invention relates to an improved structure of a large-current low-voltage transformer for a high-frequency switching-type direct-current (DC) rectifier, wherein the transformer is comprised of a ring-shaped iron core (made of materials such as dust core or nanometer crystalline silicon or amorphous silicone), which is provided with a primary side formed with winding(s) of copper wire(s) and has a secondary side that supplies an output of large current and low voltage. The secondary side is made in the form of a modular or block unit to thereby provide a novel transformer. The large amount of heat generated by the operation of the large-current low-voltage transformer is removed by cooling water by arranged a cooling water tube inside the modular unit so that the performance of the large-current low-voltage high-frequency switching-type transformer is enhanced with reduced consumption of energy and power and being easy to install, and particularly, the size of the transformer is made small and the weight reduced.

(b) Description of the Prior Art

A conventional structure of a transformer for a direct-current (DC) large-current low-voltage rectifier comprises a silicon controlled rectifier (SCR) to effect control and is generally applicable to a DC power source of large current and low voltage, such as having an output of 1-50V and 1-50,000A, or a high-frequency switching type DC rectifier. Major applications include surface treatment, such as electroplating, for example plating of printed circuit boards (PCBs) and integrated circuits (ICs), continuous plating, plating of ironware, electrolysis, chargers, and electro-deposition coating.

The transformer of the SCR is generally constructed by comprising silicon steel plates to serve as a transformer iron core and using conductive metal wires to provide a primary side in the form of winding and a secondary side in the form of winding. To cope with the needs of large current and low voltage, the transformer of the SCR suffers high iron loss and copper loss, is of low efficiency, consumes a large amount of energy and power, and is bulky. Due to the high temperature generated by the large-current low-voltage rectification operations, a cooling measure is often adopted. For example, a cooling fan can be employed to carry out forced cooling, but the cooling fan causes large noises. Another example is to use oil cooling and this often causes pollution and has a poor rectification performance

The present inventor has been working in the field and development of DC power supply devices and is aware of and uncomfortable with the bulky size and poor performance of the existing large-current low-voltage transformers. Thus, the present invention is aimed to provide a rectifier that overcomes the problems of the conventional devices.

### SUMMARY OF THE INVENTION

The primary purpose of the present invention is to provide a structure of a transformer for a high-frequency switching-type direct-current (DC) rectifier, and particularly to a novel design of a transformer applicable to a large-current low-voltage high-frequency switching-type rectifier, wherein the transformer is comprised of a ring-shaped iron core (made of materials such as dust core or nanometer crystalline silicon or amorphous silicone), which is provided with a primary side formed with winding of copper wire(s), coupling with a secondary side that is formed with a newly-developed module or block (which was constructed to provide output with copper wires or copper plate with wire wound thereon) and wherein the secondary-side module or block is internally cooled by means of water to allow the ring-shaped iron core and the primary-side winding and the second-side winding to maintain normal temperatures, providing the transformer with enhanced performance to realize saving of energy and power and reduction of size and weight of the transformer. Particularly, the transformer effects cooling by using cooling water tube, wherein the cooling water can be recollected and causes no pollution. Apparent improvement over the conventional transformer can be easily appreciated.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a transformer constructed in accordance with a first embodiment of the present invention;

FIG. 2 is a top plane view of the transformer in accordance with a first embodiment of the present invention;

FIG. 3 is an axially cross-sectional view of the transformer of the first embodiment of the present invention;

FIG. 4 is a perspective view of a transformer in accordance with a second embodiment of the present invention;

FIG. 5 is a perspective view of a transformer in accordance with a third embodiment of the present invention; and

FIG. 6 is a perspective view of a transformer in accordance with a further embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

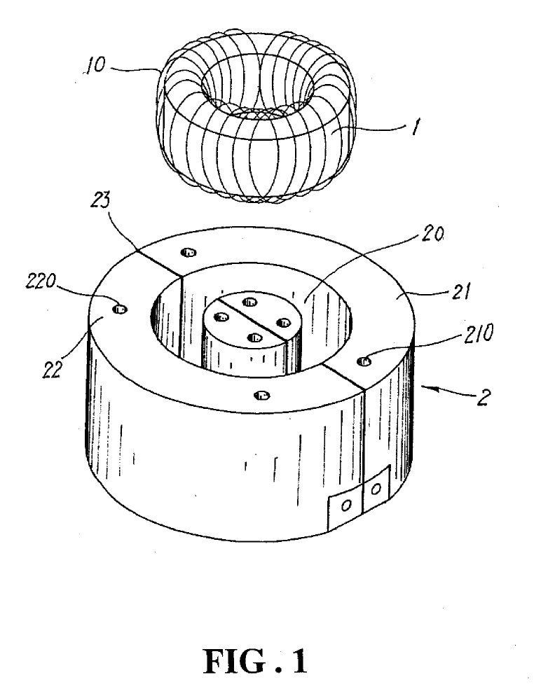

With reference to the drawings and in particular to FIG. 1, which shows an exploded view of a transformer constructed in accordance with a first embodiment of the present invention, the transformer comprises a ring-shaped iron core 1 and a secondary-side module (block) 2. The ring-shaped iron core 1 is provided with a primary-side winding 10, which is formed by winding copper wire(s). The secondary-side module 2 is formed of two combined semi-cylindrical blocks 21, 22 having a centrally located ring-shaped groove 20 and isolated by insulator 23. The secondary-side module 2 also forms therein at least one cooling water tube that forms at least one cooling water inlet hole 210 and at least one cooling water outlet hole 220.

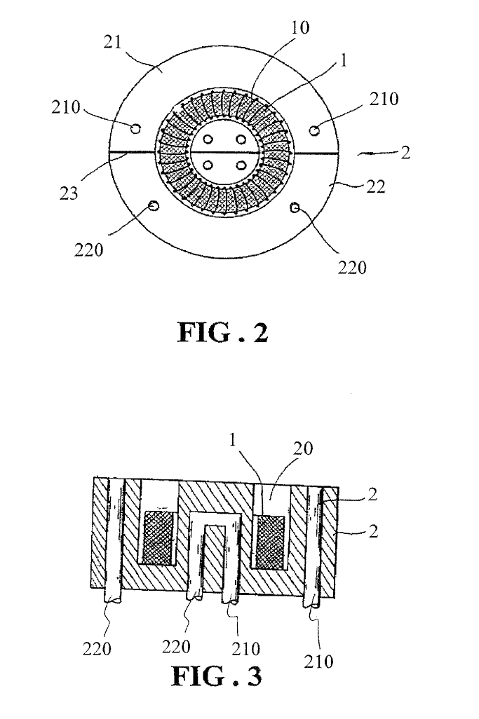

Also referring to FIG. 2, the transformer of the present invention, which is different from a conventional transformer that is made of silicon steel plates provided for a silicon-controlled rectifier (SCR) and a conventional large-current low-voltage transformer for a high-frequency switching type direct-current (DC) rectifier, is a high-frequency switching-type large-current low-voltage transformer, which comprises a ring-shaped iron core 1, which is made of the materials such as dust core, nanometer crystalline silicon and amorphous silicon, employing a primary-side winding 10 to couple with a secondary-side module 2 to realize a novel modular construction for assembling to form the transformer and further uses cooling water to remove a great amount of heat generated by the large current to provide the transformer with enhanced performance and realizing saving of energy and power.

In respect of the cooling water device, reference is made to FIG. 3, which shows an axially cross-sectional view of the secondary-side module 2. In the ring-shaped groove 20 of the secondary-side module 2, the ring-shaped iron core 1 that is provided with the primary-side winding 10 is received. Due to the high temperature generated by the large-current low-voltage rectification operation, cooling is desired to maintain normal temperature for raising the performance of the transformer and realizing saving of energy and power. In accordance with the present invention, cooling water inlet holes 210 and cooling water outlet holes 220 are formed through upper and lower surfaces of the secondary-side module 2 whereby when rectification is being carried out, cooling water is allowed to flow into the secondary-side module 2 via the cooling water inlet holes 210 and to discharge through the cooling water outlet holes 220 to remove heat and thus maintain the secondary-side module 2 at the normal temperature.

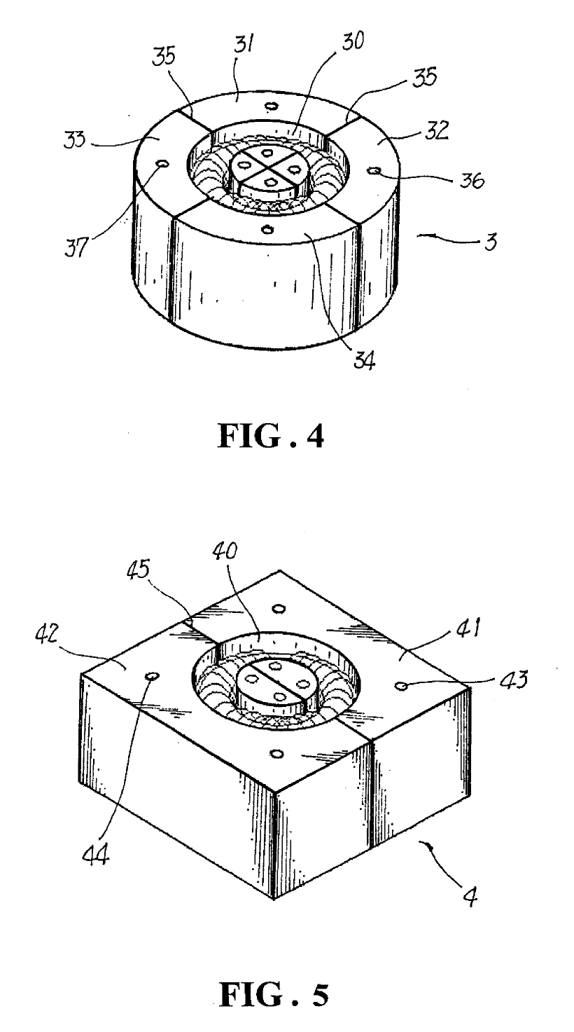

With reference to FIG. 4, which shows a perspective view of a second embodiment of the present invention, a secondary-side module 3 forms a first, centrally-located ring-shaped groove 30 and the secondary-side module 3 is divided into four segments or blocks 31, 32, 33, 34. When assembled, joining faces of each block are isolated by insulators 35. Each block similarly forms a cooling water inlet hole 36 and a cooling water outlet hole 37, so that during the operation of rectification, each block can be cooled and maintains at a normal temperature to enhance the performance of the transformer.

Further, in accordance with the present invention, the secondary-side module can be modified to have a rectangular shape, as shown in FIG. 5, which illustrates a perspective view of a third embodiment of the present invention. The secondary-side module 3 is comprised of two rectangular blocks 41, 42, which are symmetric with respect to each other and define a centrally-located ring-shaped groove 40 therebetween for receiving the ring-shaped iron core 1. The blocks 41, 42 forms cooling water inlet holes 43 and cooling water outlet holes 44. Joining faces of the blocks 41, 42 are similarly isolated by insulators 45, so as to be fit for large-current low-voltage operation and having extremely high rectification efficiency.

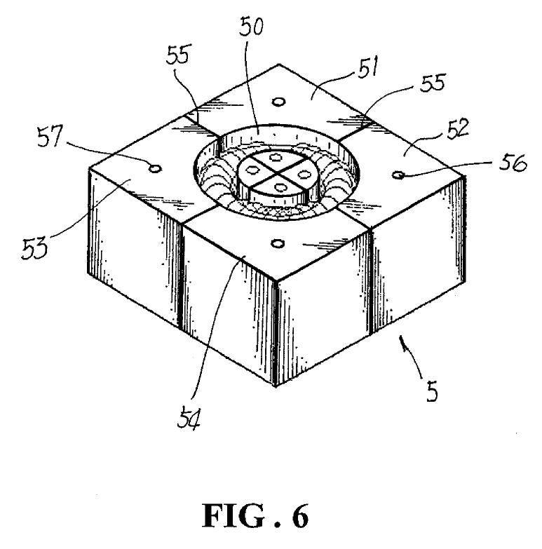

Also referring to FIG. 6, which shows a perspective view of a fourth embodiment in accordance with the present invention, a secondary-side module 5 is set in the form of a rectangular configuration and is divided into four segments or blocks 51, 52, 53, 54. When assembled, joining faces of the blocks are isolated by insulators 55 to define a centrally-located ring-shaped groove 50 for receiving the ring-shaped iron core 1 therein. Each block forms a cooling water inlet hole 56 and a cooling water outlet hole 57, so that high temperature caused during the operation of rectification can be instantaneously cooled down by the cooling water so as to raise the rectification efficiency of the secondary-side module 5 and realize saving of power and energy.

Further, the secondary-side module can of any desired configuration and shape, and the feature is that the secondary-side module forms a centrally-located ring-shaped groove for receiving the ring-shaped iron core 1 therein and is provided with cooling water inlet hole(s) and cooling water outlet hole(s) to cool down the high temperature generated during the rectification operation (which is in a large current and a low voltage), whereby the rectification performance and efficiency is enhanced. Apparently, besides the configurations discussed in the previous embodiments of the present invention, other geometry, which can be symmetric or irregular, can also be used as the shape of the secondary-side module.

To conclude, the transformer of the present invention, when carrying out rectification operation, has apparently the following advantages over the conventional ones:

(1) The ring-shaped iron core 1 of the present invention is made of materials, such as dust core or nanometer crystalline silicon or amorphous silicon, and incorporates newly developed primary-side winding and a secondary-side module (block) to form a transformer for a high-frequency switching-type rectifier, which, as compared to the conventional SCR, saves up to 20-30% power consumption, thereby realizing the purpose of saving energy and power.

(2) When the present invention is employed to carry out rectification operation, cooling water is used to effect cooling inside the transformer to realize the purposes of cooling and temperature lowering and further, the cooling water can be re-collected and causes no pollution.

(3) In the conventional SCRs, the transformer suffers high iron loss and copper loss, poor performance, and bulky size, which does not occupy a great amount of space and is very heavy. The transformer of the high-frequency switching-type rectifier in accordance with the present invention, on the contrary, is of better power saving performance and also has a smaller size with a weight of around one-twentieth of the conventional ones, making the shipping and installation easy.

(4) By means of a transformer structure that replaces the secondary side with a modular unit (block), the transformer of high-frequency switching-type rectifier in accordance with the present invention is particularly suitable for use in large-current low-voltage rectifier with excellent performance, leading to saving of energy and power and being more economic.

To conclude, the present invention provides a transformer that is comprised of a ring-shape iron core that is made of materials, such as dust core, nanometer crystalline silicon, and amorphous silicon, with the primary side in the form of winding, while the secondary side replaced by modular unit with water flowing therethrough (block type arrangement) to form the transformer, which is best suitable for large-current and low-voltage high-frequency switching-type DC control and is the best structure of transformer.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-7. (canceled)

8. A transformer comprising:
a ring-shaped iron core provided with a primary-side winding;
a secondary module formed of four combined semi-cylindrical blocks isolated by an insulator, said secondary module having a centrally located ring-shaped groove, each of said blocks having a cooling water inlet hole and a cooling water outlet hole, said cooling water inlet hole being provided on an upper surface of said blocks and said cooling water outlet hole being provided on a lower surface of said blocks thereby enabling cooling water to flow into said secondary-side module via said cooling water inlet hole and to discharge through said cooling water outlet hole to remove heat;
wherein said ring-shaped iron core with said primary-side winding is received in said ring-shaped groove of said second module.

9. The transformer as claimed in claim 8, wherein said ring-shaped iron core is made of a material selected from a group consisting of dust core, nanometer crystalline silicon and amorphous silicon.
